(19) United States
(12) Patent Application Publication
(10) Pub. No.: US 2006/0030444 A1
(43) Pub. Date: Feb. 9, 2006

(54) Timing belt rail assembly

(76) Inventor: Paul Thomas Barrett, Marietta, GA (US)

Correspondence Address: Paul T. Barrett, 1784 Halbro Drive, Marietta, GA, 30062, US

(21) Appl. No.: 11/197,475

(22) Filed: Aug. 4, 2005

Related U.S. Application Data
(60) Provisional application No. 60/599,337, filed on Aug. 6, 2004.

(51) Int. Cl. F16G 7/00; F16G 3/00; F16G 11/00

(52) U.S. Cl. 474/257; 474/256; 474/255

(57) ABSTRACT

Timing belts are used in industry for precise motion control on a variety of applications. The Timing Belt Rail Assembly facilitates the joining of a polyurethane timing belt of all pitches to be made endless with a hand held heater. The invention makes the disassembly of machinery unnecessary in order to install a timing belt.

### CROSS REFERENCE TO RELATED APPLICATION AND PRIORITY CLAIM

This application claims the benefit of U.S. Provisional Application Ser. No. 60/599,337 filed on Aug. 6, 2004.

### TECHNICAL FIELD

The present invention relates to endlessing of polyurethane timing belts.

Industry Definitions:

SPLICE: Methods for joining the ends of belting together without using a mechanical fastener.
ENDLESS: A belt made without a joint or splice.
FINGER SPLICE: Belt ends cut into mating fingers.

### BACKGROUND

Timing belts are commonly used in industrial applications around the world. Timing belts are mostly used to radially synchronize two or more shafts or to position a single point on the belt between two pulleys. Timing belts have protrusions from their bottom surface called teeth. The distance between teeth is regular (referred to as pitch), and the belts are generally manufactured in various pitches for different applications. A timing belt pulley has the profile of the teeth machined around its circumference. It is the meshing of the teeth on the belt's inner surface with the corresponding teeth in a pulley that enables a timing belt to deliver a precise measured movement in a predetermined time span.

Timing belts are constructed primarily of two types of material: rubber and polyurethane. The compounds used in making rubber timing belts can vary from manufacturer to manufacturer. These belts are usually molded and cured in an autoclave and are produced endless. The size of the mold is the determining factor of how long and wide the rubber timing belt can be supplied to the end user. The second type of timing belt is made of polyurethane. Polyurethane timing belts [PTB] are extruded both endless and extruded flat and open-ended. They have internal tension members of steel or Kevlar to minimize the elongation or stretch of the timing belt, ensuring the proper function. The present invention deals with the open ended PTB, or an endless belt that has been cut to allow a splice.

Timing belts are made in a variety of pitches. A single pitch is the distance between one point of the tooth and the same point on the next tooth. Timing belts are made in metric pitches and standard pitches. The distance between the teeth is precise to a tolerance of +/−0.001 inches.

When a timing belt needs replacing due to wear or age, it can be installed endless or spliced. If the timing belt is installed endless, some disassembly of the equipment is necessary to install the belt. Disassembly of a machine can be very time-consuming, but can be averted by splicing the timing belt on the machine. If the PTB is installed using a splice, a press consisting of two heated platens with an internal bladder to develop pressure on the PTB has been utilized. In a majority of cases, the press units are too large to fit in the equipment, leaving disassembly as the only option.

### BRIEF SUMMARY

The Timing Belt Rail Assembly [TBRA] allows a PTB to be spliced on a majority of applications without disassembly of the equipment. This is achieved by its small size; any span of belt between 6-8 inches long can be used to splice a PTB. The PTB is prepped with a finger splice and fitted into the TBRA. Once the PTB is fitted in the TBRA a small, self-clamping, hand-held hot press is fitted on the TBRA. The PTB is then left to splice for a variable period of five to fifteen minutes.

### BRIEF DESCRIPTION OF THE DRAWINGS

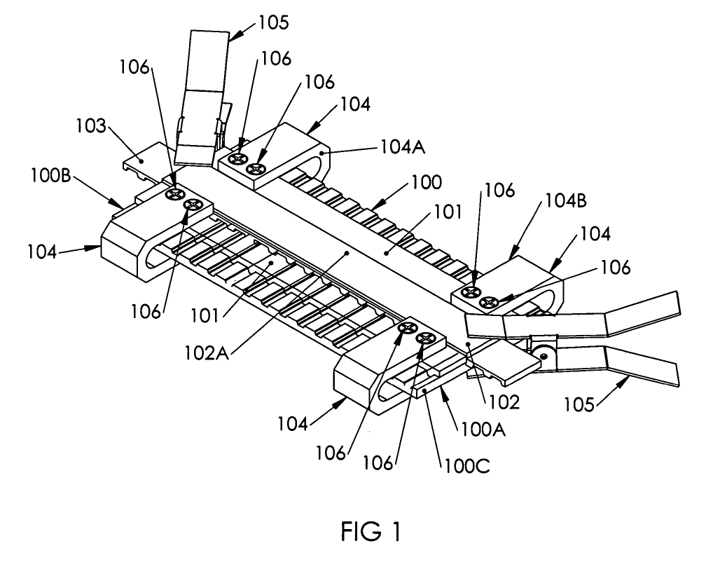

1. FIG. 1 is an isometric view of the TBRA assembled with a PTB in accordance with a preferred embodiment of the present invention.

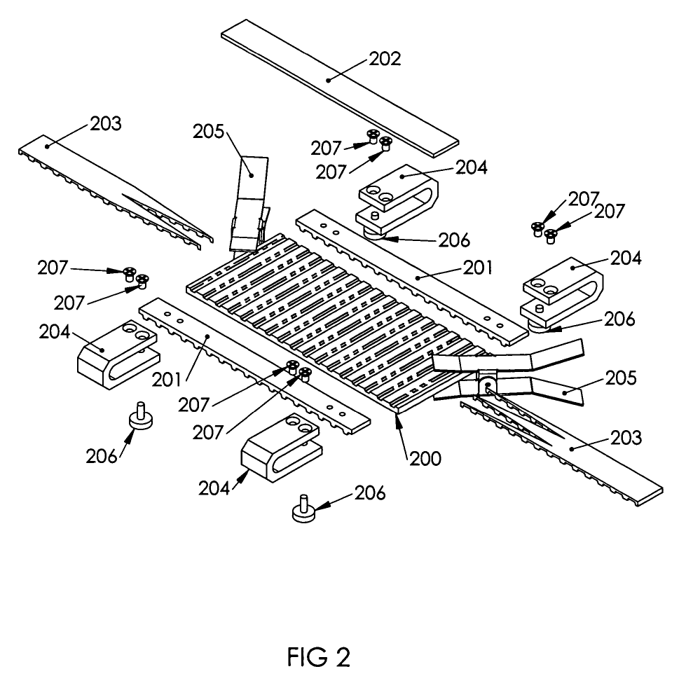

2. FIG. 2 is an exploded view of the TBRA showing all the individual components in accordance with a preferred embodiment of the present invention.

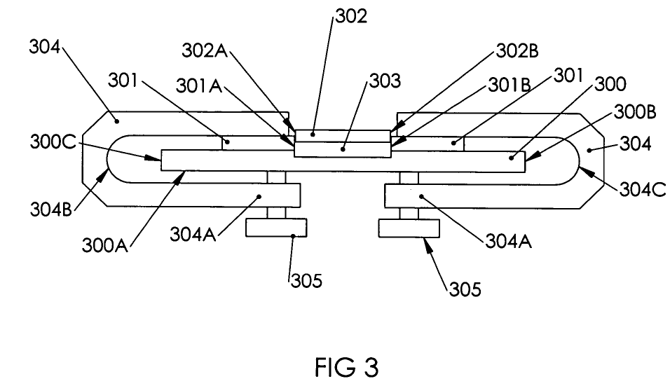

3. FIG. 3 is a right side view of the TBRA assembled with a PTB in accordance with a preferred embodiment of the present invention.

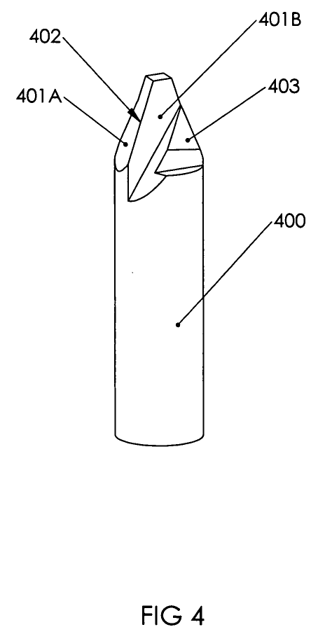

4. FIG. 4 is an isometric view of a cutting tool for the base and capture plates of the TBRA in accordance with a preferred embodiment of the present invention.

5. FIG. 5 is a top view of the cutting tool for the base and capture plates of the TBRA in accordance with a preferred embodiment of the present invention.

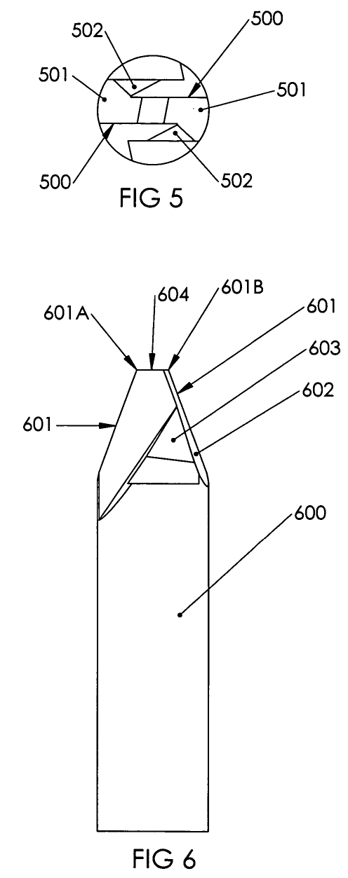

6. FIG. 6 is a projected right side view of the cutting tool for the base and capture plates of the TBRA in accordance with a preferred embodiment of the present invention.

### DETAILED DESCRIPTION

The components of the TBRA consist of a single base plate, two capture plates, and a single cover plate held together by both integral and external clamps. The base has a mating profile to the teeth of the PTB machined in its top surface; this enables the PTB to be spliced without compromising the geometry of the teeth. The base is made large enough to accommodate the spliced area of the PTB, the capture plates, and the necessary clamps. When assembled for use, the capture plates are positioned on each side of a PTB. The capture plates have a mating profile to the base plate; this acts as a seal and prevents melted polyurethane from escaping the sides of the TBRA. The capture plates are clamped to be base and, by virtue of their mating profile, can be adjusted laterally on the base thus making the TBRA adjustable to accept a variety of widths utilizing the same base plate. The integrated clamps are fixed to the capture plates by threaded fasteners. The shape of the clamp is that of a “C”. The upper extension of the clamp is fastened to the capture plates and the lower extension of clamp has a thumb knob to apply pressure to the bottom of the base. The final component of the TBRA is the cover plate. The width of the cover plate is determined by the width of the timing belt to be spliced. The cover plate is placed over the PTB and makes contact on each side with the capture plates; this prevents polyurethane from escaping the top of the TBRA.

Polyurethane reaches a melting point at 338° F. [170° C.]. The plastic materials used to make the TBRA are capable of withstanding continuous temperatures above 420° F. [216° C.]. There are a variety of plastics that could be used; currently the plastic of choice for the base and capture plates is 25% glass filled Teflon [25GFT]. The cover plate is made from a glass filled grade of phenolic called G7. The thickness of the base and capture plates are made roughly the same to allow uniform heat transfer to the PTB; this helps create a uniform splice. The specific heat transfer properties of the 25GFT and G7 are not known, but have been deemed acceptable through independent testing of the splice. An important property of the material used for the base and the capture plates is its machinability. The geometry of the teeth are exacting and require close tolerances. If the plastic material does not lend itself to machining, the resulting splice may be compromised in either strength or function.

To utilize the TBRA, the width and style of the PTB is determined. The PTB is supplied with a finger splice. The length of the finger splice on the ends of the timing belt determines the length of the TBRA. Currently two lengths of fingers are offered, 35 mm and 85 mm. A metric finger splice is utilized in both standard PTB as well as metric PTB. Accordingly, the two sizes of TBRA currently offered are 5.5″ over all length and 8.5″ over all length. Once the PTB is fitted in the TBRA, the cover plate is laid on the top of the PTB. The capture plates are placed against the edges of the PTB, making sure the capture plates and the cover plate are touching. The clamping screws are tightened, securing the capture plates. A small spring clamping device is used on each end of the assembly to secure the cover plate. The TBRA is now ready to be placed into a hand-held hot press that will achieve a temperature of at least 338° F. [170° C.]. There are many hand-held hot pressing units on the market that meet the requirements of the TBRA. The PTB remains in the assembly for a length of time that will result in proper splicing of the polyurethane. The elapsed time is usually no more than 15 minutes and can be as short a 5 minutes. This “dwell time” or length of time the assembly must remain in the hand held press is determined by several factors: Pitch, cover, backing, tension member and width. Once the PTB has reached the correct temperature for the correct time, the hot press is removed from the TBRA. The assembly must now cool. This step is expedited by placing the TBRA between two pieces of metal to draw the heat out. Once the assembly has cooled to the touch, the TBRA is disassembled in the reverse order it was assembled. The timing belt is now endless and ready to perform the function it was designed to do.

Referring now to the drawings:

FIG. 1 shows an isometric view of the TBRA in accordance with a preferred embodiment. The major components of the TBRA are a base 100, capture plates 101, cover plate 102, PTB 103, integral clamps 104, and external clamps 105. A hot press is applied to the top surface of the cover plate 102A and the bottom of the base 100A, between the integral clamp surfaces 104A, 104B. The cover plate 102 and the PTB 103 are clamped to the base 100 by the external clamps 105. The external clamps 105 are applied near the ends of the base 100B, 100C. The integral clamps 104 are fastened to the capture plates by threaded fasteners 106.

FIG. 2 shows an exploded view of the TBRA in accordance with a preferred embodiment. The components of the TBRA are a base 200, capture plates 201, cover plate 202, PTB 203, integral clamps 204, external clamps 205, thumb knob 206, fasteners 207

FIG. 3 is a right side view of the TBRA assembled with a PTB in accordance with a preferred embodiment of the present invention. The external clamps have not been shown for clarity. The components seen are the base 300, capture plates 301, cover plate, 302, PTB 303, integral clamps 304, and thumb knobs 305. A preferred embodiment has the PTB 303 surrounded on each side by the capture plate surfaces 301A, 3011B and the cover plate 302. The inside surfaces of the capture plates 301A, 301B should contact the edges of the cover plate 302A, 302B. This will prevent melted polyurethane from escaping during splicing. The thumb knobs 305 are threaded into the lower extension of the integral clamp 304A and press against the bottom surface of the base 300A to hold the capture plates 301 in position. A preferred embodiment will allow clearance between the edges of the base 300B, 300C and the inside edges of the integral clamps 304B, 304C. This clearance will allow the capture plates 301 to be positioned for varying widths of PTB 303.

FIG. 4 is an isometric view of a cutting tool for the base and capture plates of the TBRA in accordance with a preferred embodiment of the present invention. The cutter is used to form the recess in the base to receive the teeth of the PTB. The key elements to the cutter are the main body 400, relief faces 401A, 401B, the cutting edge 402, and a clearance face 403. The purpose of this view is to better understand the geometry of the cutter, as FIG. 5 and FIG. 6 may need further clarification. The cutter is formed by grinding a high-speed steel end mill blank into the shown geometry. The actual size of the cutter varies by the pitch of the PTB. The angle between the relief faces 401A, 401B must create a positive rake for proper chip formation during machining. The clearance face must be formed so that only the cutting edges 402 of the cutter contact the material.

FIG. 5 is a top view of the cutting tool for the base and capture plates of the TBRA in accordance with a preferred embodiment of the present invention. The key elements of the cutter are the cutting edges 500, relief faces 501, and clearance faces 502. The preferred rotation of the cutter is counterclockwise as shown in this view.

FIG. 6 is a projected right side view and a projected top view of the cutting tool for the base and capture plates of the TBRA in accordance with a preferred embodiment of the present invention. The components of the cutter are the main body 600, cutting edge 601, relief face 602, and clearance face 603. The included angle between the two cutting edges must be equal to the included angle of the teeth of the PTB. The distance between the ends of the cutting edges 601A, 601B must be smaller than the top of a single tooth on the PTB. This is to allow the cutter to make incremental passes to form the recess in the base of the TBRA during machining. If the distance is too great, it will be difficult to control the geometry of the recess. The surface 604 on the bottom of the cutter must be flat and perpendicular to the central axis of the cutter.

1. A device that joins PTBs; consisting of a base, capture plates, a single cover plate, integral clamps, and external clamps;
device of claim one wherein the top surface of the base is machined to match the tooth profile of a particular PTB; and
device of claim one wherein the bottom surface of the capture plates are machined to have a mating profile to the top surface of said base; and
device of claim 1 wherein the width of the cover plate is made to match the width of said PTB; and
device of claim one wherein the integral clamps secure the capture plates to the base; and
device of claim one wherein the the external clamps secure the cover plate to the base.

2. The PBT pitches claimed for the TBRA are T-5, T-10, T-20, AT-5, AT-10, AT-20, 8M, 14M, L, XL, and H.
